(19) United States
(12) Patent Application Publication
(10) Pub. No.: US 2026/0129042 A1
(43) Pub. Date: May 7, 2026

(54) METHOD AND SYSTEM FOR AUTHENTICATING USER USING ML DICTATION SUPPORT

(71) Applicant: FRIENDLYBUZZ COMPANY, PBC, Surfside, FL (US)

(72) Inventors: Michael Marelus, Antwerp (BE); Meier Marelus, Antwerp (BE); Levi Marelus, Antwerp (BE); Myriam Harroch, Antwerp (BE); Gila Chacham, Berchem (BE)

(21) Appl. No.: 18/936,915

(22) Filed: Nov. 4, 2024

(51) Int. Cl. H04L 9/40; G06F 21/32; G10L 17/24

(52) U.S. Cl. CPC H04L 63/0861; G06F 21/32; G10L 17/24; H04L 63/083; H04L 63/0876

(57) ABSTRACT

What is claimed is a system and method of authenticating a user to a service on a computing system, including obtaining, from the user, a spoken audio input signal relating to at least one authentication credential for the service, determining from the spoken audio input signal the at least one authentication credential, using at least one language-based machine learning, ML, model trained for analyzing an input signal pertaining to the spoken audio input signal; and triggering at least one authentication attempt to the service using the determined at least one authentication credential.

### TECHNICAL FIELD

The present disclosure generally relates to user authentication to a service. Particular embodiments relate to a method of authenticating a user to a service, and to a related computer program, non-transitory computer-readable storage medium, and computing system.

### BACKGROUND

In certain situations, a user may desire to access a service, e.g. a WLAN in a home setting. To do so, the user needs to supply or prove certain authentication credentials. In some cases, the user additionally needs to know further specific information, e.g. which WLAN is to be used, and where and how to supply the authentication credentials in order to authenticate themselves to the WLAN.

Conventionally, the user needs to manually enter the authentication credentials into an authentication interface, which is typically but not always a visual interface. The visual interface that the user can use may typically be provided by a computing system such as the user's personal computer, PC, or smart device, e.g. a smartphone, and the operation of entering is generally conducted through a touchscreen or keyboard and the output (e.g. prompt to input password; success message; etc.) is generally output on the visual interface too.

The operation of entering the authentication credentials requires that the user takes great care to type the relevant data, in string format, into the visual interface. This is especially the case for passwords, but also for other kinds of authentication credentials.

### SUMMARY

Given that there is a desire for security, in particular if the authentication credentials comprise a password or passkey or passphrase, the string to be typed by the user is typically a long (e.g. 8 or more characters or even 14 or more characters), complicated (and ideally even random) string of characters, optionally including various non-alphanumeric symbols. This means that the user may find typing the string, for example by way of a touch screen or a keyboard, burdensome.

Moreover, the user may make human mistakes when typing the string, for instance due to the length and/or the complexity of the string, which increases the overall time and effort required to authenticate to the service.

These concerns don't apply for passwords only, as similar concerns may apply to other types of authentication credentials, e.g. the WLAN's identifier, including for example where (especially in urban settings) there may be many locally co-existing WLANs, and these may be distinguished only by a difference that is relatively subtle for the average user (e.g. “dlink-AB12-2.4 GHz”, “dlink-AB21-2.4 GHz”, and “dlink-AB12-5 GHz”).

Moreover, in order for a user to select, for example, a WLAN and/or type a password, for example, the computing system needs to include a keyboard and/or a touchscreen and a related graphical user interface, and related driver software.

It is an aim of at least some embodiments of the present disclosure to address the shortcomings described herein.

Accordingly, the present disclosure provides embodiments according to the included claims.

The embodiments described herein are provided for illustrative purposes and should not be construed as limiting the scope of the invention. It is to be understood that the invention encompasses other embodiments and variations that are within the scope of the appended claims. The invention is not restricted to the specific configurations, arrangements, and features described herein. The invention has wide applicability and should not be limited to the specific examples provided. The embodiments disclosed are merely exemplary, and the skilled person will appreciate that various modifications and alternative designs can be made without departing from the scope of the invention.

### BRIEF DESCRIPTION OF THE DRAWINGS

In the following description, a number of exemplary embodiments will be described in more detail, to further help understanding, with reference to the appended drawings, in which:

FIG. 1 schematically illustrates a flowchart of an exemplary embodiment of a method 100 according to the present disclosure;

FIG. 2 schematically illustrates a system diagram of an exemplary embodiment of a computing system 1000 according to the present disclosure; and

FIG. 3 schematically illustrates a system diagram of an exemplary embodiment of a computing system 1100 according to the present disclosure.

### DETAILED DESCRIPTION

In particular, in a first aspect of the present disclosure, there is provided a method of authenticating a user to a service; the method comprising, on a computing system:
obtaining, from the user, a spoken audio input signal relating to at least one authentication credential for the service;
determining from the spoken audio input signal the at least one authentication credential, using at least one language-based machine learning, ML, model trained for analyzing an input signal pertaining to the spoken audio input signal; and
triggering at least one authentication attempt to the service using the determined at least one authentication credential.

In this manner, the above-described disadvantage of burdensome string entry can be reduced. On the one hand, the user can simply provide a spoken audio input signal, which takes less effort than typing. On the other hand, mistakes can occur in speaking and/or in transcription, but the at least one language-based ML model can compensate for these mistakes. This fruitful combination can help to add a level of forgiveness, and thus to ensure that the overall outcome is more accurate.

Note of course that the method may serve for at least tentatively authenticating a user to a service, in the sense that the method may be allowed to fail if the at least one authentication credential eventually proves incorrect. From the point of view of a skilled person implementing the presently-described method, this is immaterial (because the authentication is an attempt that is triggered, and is not limited to an authentication as such) to the technical implementation.

Determining the at least one authentication credential from the spoken audio input signal may for example comprise simply extracting the credential from the signal, for example, if it can be assumed that the input is in a directly suitable form, and/or may include more than simply extracting, e.g. processing and/or otherwise modifying.

Note that the expression “relating to” may indicate that the at least one authentication credential is included as such in (for example a (literal or modified) transcription of) the spoken audio input signal, in the sense that the actual wording of the at least one authentication credential is present in the spoken audio input signal. Alternatively, the meaning of ‘relating to’ may involve that the at least one authentication credential may be detectable and/or derivable from the spoken audio input signal, e.g. if the at least one authentication credential is a modified or otherwise processed form of the originally present wording, and is therefore not obtained in the actual wording as such.

An example of a language-based ML model trained for analyzing an input signal pertaining to the spoken audio input signal may be a ML model trained more specifically for generating conversation responses in response to conversation prompts.

Any request, failure notification, or other notification or communication directed to the user may be communicated to the user in an audio format.

The at least one authentication credential may comprise at least one valid authentication credential and/or at least one invalid authentication credential. An authentication credential is valid if it is fit for the purpose of authenticating to the service, whereas the authentication credential is invalid if it is unfit for said purpose. Naturally, the at least one authentication credential may comprise a possible and/or plausible authentication credential. Naturally, the same may be true as regards any reference to any credential, such as for example a password or WLAN ID. Naturally, the same may be true as regards any reference to any credential, such as for example a password or WLAN ID.

The computing system may use the same or different language-based ML models for the tasks of determining on the one hand and optionally responding conversationally (either in written form, or via speech output, or both) to the user. The computing system may use the same language-based ML model(s) or one or more different ML models to for example further exert agency on the environment, for example in order to actually trigger the authentication attempt.

The service may be provided locally on the computing system (e.g. the service may simply be the user login service of the user's personal computer operating system or of the user's smart device operating system). Additionally or alternatively, the service may be provided by a different computing system. For example, the service may be (access to) a wireless local area network, WLAN, in which case the user's personal computer or smart device may attempt to authenticate to an access point of the WLAN using embodiments of the present disclosure. In another example, the service may be provided by a remote server to which the user's personal device can connect. In yet another example, the service may comprise access to a digital account of the user.

In various embodiments, the service is any one or more selected from the following: a wireless local area network; a virtual private network; and a digital account, such as a personal computer account or a social media account, an email account, a banking account, etc.

In various embodiments, the language-based ML model is a large language model, LLM, or is based on an LLM.

A language-based ML model can be defined as a ML model trained at least for outputting language output (e.g. a conversation response) in response to language input (e.g. a conversation prompt). Examples of such language-based ML models include, but are not limited to, large language models such as GPT-3.5, GPT-4, GPT-4o, Gemini, BERT, Bard, LaMDA, Mistral, Orca, Palm, BLOOM, Claude 2, GPT-J, Llama, RoBERTa, etc.. Note that a ML model may be multi-modal (e.g. be adapted to process both text and sound) yet still be considered language-based (and, in this example, audio-based as well).

In various embodiments, a language-based ML model may provide as part of its inherent functionality a function of dictation transcription. Note that this may differ from using a language-based ML model and a separate speech-to-text engine that is not integral with the model. In various embodiments, a language-based ML model may be able to process audio as input directly and/or generate audio as output.

It is noted, that a reference to a ‘transcription’ herein may be a textual representation of input or output (e.g. for example where a language-based ML model is used which is capable of processing audio as input and generating text (and/or audio) as output, and where audio is provided as input to such model and such model provides text output, such as for example several possible passwords generated on the basis of the audio input, such text output may be called a transcription even though it is not a transcription of the audio input).

In various embodiments, said step of determining comprises:
providing said at least one authentication credential, in the form of an audio input signal and/or in the form of a text input signal, to the at least one language-based ML model and prompting the at least one language-based ML model to obtain at least one variant representation of said at least one authentication credential;
wherein the at least one language-based ML model is configured to take as input an initial representation, and to output one or more variant representations comprising one or more probable corrections to the initial representation.

In various embodiments, said step of determining comprises:
providing said at least one authentication credential, in the form of a text input signal, to the at least one language-based ML model and prompting the at least one language-based ML model to obtain at least one variant textual representation of said at least one authentication credential;
wherein the at least one language-based ML model is configured to take as input an initial textual representation and to output one or more variant textual representations comprising one or more probable corrections to the initial textual representation.

In various embodiments, said step of determining comprises:
providing said spoken audio input signal in the form of an audio input signal to the at least one language-based ML model and prompting the at least one language-based ML model to obtain at least one variant textual representation of said at least one authentication credential;
wherein the at least one language-based ML model is configured to take as input a spoken audio input signal and to output one or more textual representations comprising one or more probable corrections to the audio input signal.

For the avoidance of doubt, in an embodiment, a variant transcription may be a corrected transcription.

In further embodiments, the spoken audio input signal referred to in any of the embodiments described herein may comprise at least one authentication credential. A spoken audio input signal may also be considered to comprise as such an originally intended authentication credential which is semantically present in the audio, and is thus comprised therein, even if not literally comprised as such. In other words, and as an example of this, in a further embodiment, there is a method of authenticating a user to a service; the method comprising, on a computing system:
obtaining, from the user, a spoken audio input signal comprising at least one authentication credential for the service;
determining from the spoken audio input signal the at least one authentication credential, using at least one language-based machine learning, ML, model trained for analyzing an input signal pertaining to the spoken audio input signal; and
triggering at least one authentication attempt to the service using the determined at least one authentication credential.

In a further embodiment, when using an audio-to-audio model (i.e. there is thus no need for transcription), the ML model may be configured to take as input the audio and to output one or more possible or likely credentials (or IDs, etc, as the case may be) picked up from and/or otherwise based on the audio.

When referring to at least one modified transcription of said at least one authentication credential, this may refer to having one or more ML model(s) generate a single or numerous alternative possible credentials—e.g. if the input is identified as BASSWORD11EUM22, the one or more ML model(s) may generate numerous possible credentials such as PASSWORD1122, PASSWORD 1122, BASSWORD1122 and a triggering may be done for each of these.

In various embodiments, the method may comprise configuring the at least one language-based ML model to operate using a dictation transcription model.

Said step of “using” the dictation transcription model may be e.g. performed by including within the computing system a component configured as a dictation transcription model, and/or may be performed by cooperating with a separately embodied dictation transcription model, e.g. a speech analysis engine, such as the publicly available open-source Whisper speech-to-text engine.

It is noted that a dedicated dictation transcription model may be used (as detailed herein), but that it may instead be the case that the function of speech analysis/transcription is implicitly a part of, or otherwise works with, a larger overall artificial intelligence, AI, element or elements. Furthermore, additionally or alternatively, it may implicitly be a part of, or otherwise work with, a larger overall artificial intelligence, AI, element or elements that can process audio input signals, e.g. one or more machine learning, ML, models, such as for example an audio-to-audio ML model (e.g. a model that can process audio as input and generate audio as output). By optionally using a dictation transcription model and at least one ML model separate from the dictation transcription model a clear separation of concerns can, for example, be achieved, and each AI element may, for example, be put to task for the kind of task that it is most specialized for. It is noted, however, that the dictation transcription model and the ML model may also be part of a single system, or a single ML model, or indeed be a single processing system serving as either both or one of them, rather than separate.

In various embodiments, the obtained spoken audio input signal relates to at least one first authentication credential, and the at least one first credential is determined from the spoken audio input signal. The method further may comprise generating at least one second authentication credential, preferably based on the at least one first authentication credential (or for example using a heuristic based on the at least one first authentication credential), or preferably using an independent heuristic, for example a heuristic based on a predefined set of probable passwords (e.g. a most popular password list, according to publicly available sources; or for example based on possible natural language misunderstandings and/or mispronunciations such as a letter “N” may be generated instead of a inputted letter “M” and vice versa). Said step of “generating” can optionally be performed using said at least one language-based ML model, to generate potential authentication credentials, e.g. passwords. In this case, the at least one authentication attempt is of course triggered using the at least one determined first authentication credential and, where necessary, the at least one generated second authentication credential. Furthermore, such authentication attempts may be conducted sequentially (e.g. authentication may be attempted with a second authentication credential only if the authentication with the first authentication credential fails) or at the same time. Of course, an ML model may do so even without it being provided with specific instructions on how to generate one or more modified authentication credentials (e.g. it need not be provided a lists of possible letter, numerical, etc possible exchanges: “N”, “M”, “P”, “B”, etc.).

In other words, the method may include transcribing just one or more authentication credentials but guess, determine or otherwise generate one or more other authentication credentials. As regards guessing, this may be on the basis of the audio input (e.g. if the audio input is understood to be BASSWORD12 (e.g. audio is transcribed as BASSWORD12), it may guess the likely and/or possible password to be PASSWORD12 (as the B is likely a wrong transcription of the letter P)).

In further embodiments, the method may comprise operating the at least one ML model to process some or all spoken audio input signal input as a dictated input.

In a second aspect of the present disclosure, there is provided a method of authenticating a user to a wireless local area network, WLAN; the method comprising, on a computing system (1000, 1100):
obtaining, from the user, a spoken audio input signal relating to at least one of: an identifier, ID, for the WLAN, and a password for the WLAN;
determining from the spoken audio input signal the ID and/or the password, using a language-based machine learning, ML, model trained for analyzing an input signal pertaining to the spoken audio input signal; and
triggering at least one authentication attempt to the WLAN using the determined ID and/or password.

The above embodiment of the second aspect may be considered equivalent to the above-described method of the first aspect, wherein the service is a wireless local area network, WLAN, and wherein the at least one authentication credential relates to at least one of: an identifier, ID, for the WLAN, and a password for the WLAN.

The ID for the WLAN may preferably be the Service Set Identifier, SSID, of the WLAN.

In a further embodiment, where the system already knows which WLAN ID is that of the user (for example, because a user has already set up a profile that includes the relevant WLAN ID), in such case the method may comprise obtaining a password for the known WLAN, determining the password, and triggering the at least one authentication attempt. Advantageously, the method may thus not need to undertake any WLAN ID scanning, as set out elsewhere herein.

In a further embodiment, the method may include prompting the user to provide a relevant WLAN ID (e.g. by way of an audio output signal using a speech synthesis engine) and additionally, but not necessarily, matching the input to the results of its scan, as described elsewhere herein, if any, of WLAN IDs. Such matching may be done, for example, through the support of one or more ML models, such as for example a language-based machine learning, ML, model. For example, the user may provide, via an audio input signal, that their WLAN ID is XYZ345, and an ML model (whether dedicated for this purpose or not) may be fed the results of the scan of WLAN IDs and the user input signal (whether the audio input signal proper or a transcription of said audio input signal) to determine the WLAN ID most likely relevant (i.e. having a closest match to the user's input provided by voice, and the output of the LLM may then trigger the backend to select and/or connect to the WLAN ID).

In a third aspect of the present disclosure, there is provided a method of authenticating a user to a wireless local area network, WLAN; the method comprising, on a computing system (1000, 1100):
obtaining, from the user, a first spoken audio input signal relating to an identifier, ID, for the WLAN;
determining from the first spoken audio input signal the ID, using a language-based machine learning, ML, model trained for analyzing an input signal pertaining to the spoken audio input signal;
obtaining, from the user, a second spoken audio input signal relating to a password for the WLAN;
determining from the second spoken audio input signal the password, using a language-based machine learning, ML, model trained for analyzing an input signal pertaining to the spoken audio input signal; and
triggering at least one authentication attempt to the WLAN using the determined ID and password.

The above embodiment of the third aspect may be considered equivalent to the above-described method of the second aspect, wherein the obtained spoken audio input signal relates to both the ID for the WLAN and the password for the WLAN, and wherein both the ID and the password are determined from the spoken audio input signal, and wherein the at least one authentication attempt is triggered using both the ID and the password.

In another aspect of the present disclosure, there is provided a method of authenticating a user to a wireless local area network, WLAN; the method comprising, on a computing system (1000, 1100):
obtaining, from the user, a spoken audio input signal relating to an identifier, ID, for the WLAN;
determining from the spoken audio input signal the ID, using a language-based machine learning, ML, model trained for analyzing an input signal pertaining to the spoken audio input signal;
guessing a password for the WLAN, preferably using a heuristic based on the ID of the WLAN, preferably using a predefined set of probable passwords, optionally using said language-based ML model to generate potential passwords; and
triggering at least one authentication attempt to the WLAN using the determined ID and the guessed password.

The above embodiment of the other aspect may be considered equivalent to the above-described method of the second aspect, wherein the obtained spoken audio input signal relates to the ID for the WLAN, and wherein the ID is determined from the spoken audio input signal, wherein the method comprises guessing a password for the WLAN, preferably using a heuristic based on the ID of the WLAN, preferably using a predefined set of probable passwords (e.g. a most popular password list, according to publicly available sources), optionally using said language-based ML model to generate potential passwords; and wherein the at least one authentication attempt is triggered using the determined ID and the guessed password.

In various embodiments, the at least one authentication attempt is triggered concurrently with the following additional operations:
obtaining, from the user, a second spoken audio input signal relating to a password for the WLAN;
determining from the second spoken audio input signal the password, using a language-based machine learning, ML, model trained for analyzing an input signal pertaining to the spoken audio input signal;
preferably, if the concurrently triggered at least one authentication attempt is successful, halting said additional operations of obtaining and determining; and
if the determined password differs from the first used password, triggering at least one new authentication attempt to the WLAN using the determined ID and the later determined password.

In a fourth aspect of the present disclosure, there is provided a method of authenticating a user to a wireless local area network, WLAN; the method comprising, on a computing system (1000, 1100):
detecting an identifier, ID, for the WLAN by scanning a radio frequency range accessible to the computing system;
obtaining, from the user, a spoken audio input signal relating to a password for the WLAN;
determining from the spoken audio input signal the password, using a language-based machine learning, ML, model trained for analyzing an input signal pertaining to the spoken audio input signal; and
triggering at least one authentication attempt to the WLAN using the detected ID and the determined password.

The above embodiment of the fourth aspect may be considered equivalent to the above-described method of the second aspect, comprising: detecting an identifier, ID, for the WLAN by scanning a radio frequency range accessible to the computing system; wherein the obtained spoken audio input signal comprises the password for the WLAN, and wherein the password is determined from the spoken audio input signal, and wherein the at least one authentication attempt is triggered using both the ID and the password.

The above embodiment of the fourth aspect may include the steps of generating alternative possible passwords, as described elsewhere herein, and triggering at least one authentication attempt to the WLAN using the detected ID and the one more determined possible passwords.

In a further embodiment, the step of detecting an identifier, ID, for the WLAN may be performed in a different manner (such as for example using network discovery protocols, location-based services, etc.).

### In various embodiments, said step of detecting the ID for the WLAN by scanning comprises:

if no IDs are detected in said scanning, outputting a failure notification to the user, and re-attempting or halting the method;
if one ID is detected in said scanning, setting said one ID as the ID of the WLAN to be authenticated to; or
if multiple IDs are detected in said scanning, either:
transparently to the user, and optionally in an iterative manner, selecting at least one ID from the multiple detected IDs as the ID of the WLAN to be authenticated to, by making use of a pre-defined heuristic, preferably based on ranking respective Relative Signal Strength Identifier, RSSI, values of the multiple detected IDs; or
outputting to the user at least one ID of the multiple IDs;
receiving from the user selection data designating an ID of the at least one output ID; and
selecting the designated ID as the ID of the WLAN to be authenticated to.

Preferably, the step of selecting may comprise selecting more than one WLAN ID. The choice of more than one WLAN ID is specifically well-grounded in the sense that it is likely to include the correct one. Similarly, it may select several but not all WLANs available in the area, thereby limiting the number of WLANs the system may attempt to connect to (e.g. one would ideally not want the system to attempt to connect, using the expected correct password, to all or many WLANs in the area that are picked up in the area).

Preferably, the step of outputting to the user may comprise outputting one or more WLAN IDs, and, additionally or alternatively, the full ID need not be communicated to the user (e.g. the system may say “Oh, I see two Spectrum wifis, one ending with B4 and one with F7. Which is yours? ”), and/or the system may communicate the one or more WLAN IDs to the user in other convenient natural language (e.g. conversational style). Similarly, for example, regarding the step of receiving (130), the user may provide the full WLAN ID or, as above, parts of it (e.g. the user may input: “It's the one ending with B7.”) or use other convenient natural language. For this too, the system may be supported by one or more ML models, as described elsewhere herein.

Similarly, where the system is so set up to output more than one WLAN IDs, it may communicate these to the user one by one (e.g. “Is it XYZ123?”) and wait for user response (e.g. “Nope”) before communicating others, or it can communicate several or all in one go (e.g. “Is it XYZ123, ABS534, or LJSH666?”). As regards the step of receiving, this step may include receiving from the user selection data designating at least one of the at least one output WLAN ID and may include receiving from the user data indicating a negative, such as for example a user telling the system that the WLAN ID referred to is not the user's WLAN ID.

In various embodiments, the at least one ID of the multiple IDs is output to the user via a visual display or an audio speaker or a combination thereof; and wherein the selection data from the user comprise a spoken audio selection input signal or a click or touch selection input signal.

In various embodiments, the at least one authentication credential determined is output to the user via a visual display or an audio speaker or a combination thereof; and the user response may comprise a spoken audio input signal or a click or touch input signal.

In a fifth aspect of the present disclosure, there is provided a computer program (800) comprising computer-executable instructions configured for, when executed by a computing system (1000, 1100), causing the computing system to perform the method (100) of any one of the above-described embodiments.

In a sixth aspect of the present disclosure, there is provided a non-transitory computer-readable storage medium (900) storing the computer program (800) of the above-described embodiment.

In a seventh aspect of the present disclosure, there is provided a computing system (1000) comprising at least one processor (1010) and at least one memory (1020); the at least one memory storing the computer program (800) of the above-described embodiment.

In an eighth aspect of the present disclosure, there is provided a computing system (1100) comprising means configured for performing the method (100) of any one of the above-described embodiments.

In a ninth aspect of the present disclosure, there is provided a computing system (1000) for authenticating a user to a service; the computing system comprising at least one processor (1010) and at least one memory (1020), the at least one memory storing computer-executable instructions configured for, when executed by the processor, causing the computing system to perform:
obtaining, from the user, a spoken audio input signal comprising at least one authentication credential for the service;
determining from the spoken audio input signal the at least one authentication credential, using at least one language-based machine learning, ML, model trained for analyzing an input signal pertaining to the spoken audio input signal; and
triggering at least one authentication attempt to the service using the determined at least one authentication credential.

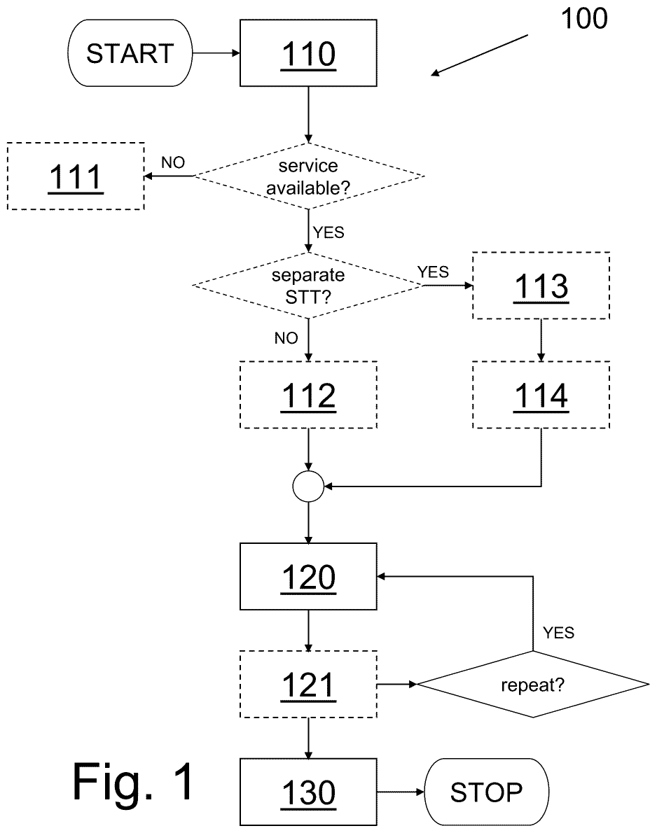

FIG. 1 schematically illustrates a flowchart of an exemplary embodiment of a method 100 according to the present disclosure.

Step 110 represents obtaining, from the user, a spoken audio input signal comprising at least one authentication credential for the service.

Step 120 represents determining from the spoken audio input signal the at least one authentication credential, using at least one language-based machine learning, ML, model trained for analyzing an input signal pertaining to the spoken audio input signal.

Step 121 is optional and represents checking whether the determined at least one authentication credential satisfies a sufficiency criterion and/or validity criterion, and, if not (i.e. it the step of determining should be repeated) repeating step 120.

Step 130 represents triggering at least one authentication attempt to the service using the determined at least one authentication credential.

The figure further shows several optional variant embodiments, represented with dashed lines.

At some point (in this example, after step 110, but it may also be earlier), the method may optionally include a step of checking whether a service is available (i.e. reachable) at all. If not, then the method may be halted 111 prematurely.

Additionally or alternatively, once the spoken audio input signal has been obtained in step 110, the method may optionally include a step of using a separate speech-to-text (STT) engine.

If that is the case, then the task of determining may be split up in a step of text transcription 113 of the at least one authentication credential using an STT engine (which may but need not be separate from the at least one ML model), and a subsequent step of prompting the language-based ML model to obtain one or more modified transcription(s) 114 of said at least one authentication credential. Preferably, the language-based ML model is configured to take as input an initial transcription, or to generate an initial transcription, and to output a corrected transcription comprising one or more probable corrections to the initial transcription. For the avoidance of doubt, any steps set out in any of the embodiments herein, such as for example the steps of 113 and 114, may, where relevant, be taken consecutively or in any order and need not be separate steps, e.g. a ML model may do both steps at the same time and as part of a single action (e.g. the ML model may provide one more more possible credentials without needing to also (explicitly or implicitly) first transcribe the audio input). For example, an audio-in and text-out ML model (whether or not also being capable of other input or output forms) may process the audio input and directly provide one or more textual representations of likely user credentials (e.g. skipping an initial plain transcription of the audio provided).

If that is not the case, then the task of determining may be simply handed over 112 to the language-based ML model for it to generate one (or more) likely authentication credential(s).

In either case, the outcome 120 is that the at least one authentication credential is determined from the spoken audio input signal, using the at least one language-based ML model trained for analyzing an input signal pertaining to the spoken audio input signal.

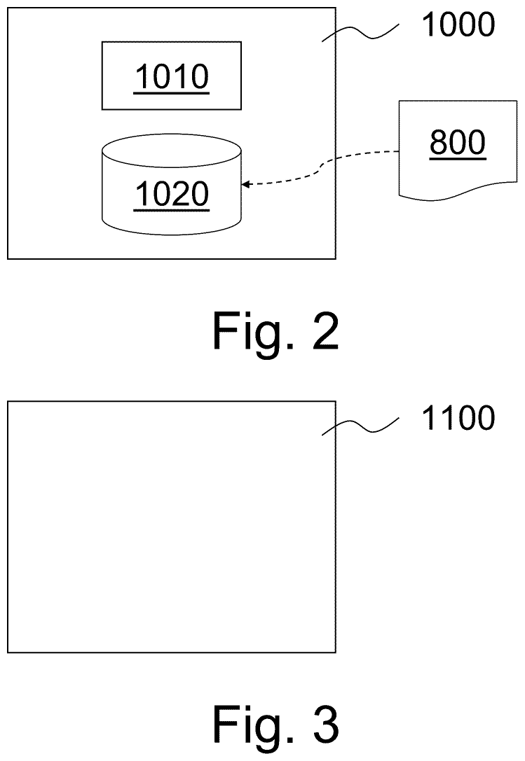

FIG. 2 schematically illustrates a system diagram of an exemplary embodiment of a computing system 1000 according to the present disclosure. The computing system 1000 comprises at least one processor 1010 and at least one memory 1020. The at least one memory stores a computer program 800 comprising computer-executable instructions configured for, when executed by a computing system 1000, causing the computing system 1000 to perform the method 100 of any one of the above-described embodiments.

FIG. 3 schematically illustrates a system diagram of an exemplary embodiment of a computing system 1100 according to the present disclosure. The computing system 1100 comprises means configured for performing the method 100 of any one of the above-described embodiments.

In a further embodiment, as regards any steps of any embodiment set out herein, the method may conduct two or more steps simultaneously where possible and (preferably) beneficial. For example, in the fourth aspect of the present disclosure, the method may detect an identifier, ID, for the WLAN by scanning a radio frequency range accessible to the computing system concurrently with obtaining, from the user, a spoken audio input signal comprising a password for the WLAN.

The approach of the embodiments described herein improve ease of use, for all users and especially for users of younger or older age or users with certain physical disabilities as it allows authentication to be made through voice.

Additional benefits of the embodiments described herein include that there is no specific need for a keyboard and screen, or touchscreen, or similar means for interaction.

Further advantages of the embodiments described herein may include increased speed and ease of data entry and (consequently) an improved time duration of the overall authentication setup, in particular because some steps can be skipped, guessed, parallelised, etc.

In various embodiments, any communication, notification (e.g. failure notification) or other output directed to the user may be communicated to the user in an audio format. Additionally, the content for such communication may be generated by one or more machine learning, ML, model(s), such as for example a large language model or multimodal large language model. Where an ML model generates audio, such audio may be played to the user. Where an ML model generates text, such text may be used in generating audio output (e.g. through a speech synthesis engine) and such audio may be played to the user.

Optionally, in various embodiments, after a successful authentication attempt to the at least one designated WLAN ID, the method may further comprise outputting to the user a confirmation notification of said successful authentication attempt.

In various embodiments, the method may optionally comprise outputting to the user other notifications or messages (e.g. error, input/output related notifications). Any such notifications or messages may be communicated to the user by way of a speech synthesis engine. In various embodiments, the method may include an ML model, preferably an LLM model, to generate the communications to the user (e.g. as regards content, as regards tone and style (e.g. conversational) and/or context (e.g. personalize the communication with the name of user, etc.)).

In various embodiments, there is provided a method of understanding a user's audio input and generating an audio response to such user; the method comprising, on a computing system:
obtaining, from the user, a spoken audio input signal generated by the user;
providing said audio input signal in the form of an audio input signal and/or in the form of a text input signal (e.g. a transcription of the audio input signal) to one or more language based ML model(s), and prompting the one or more language based ML model(s) to generate one or more suitable response to such user audio input signal (and such responses may e.g. be in the form of text and/or audio); and
outputting a response to the user.

In various embodiments, the method may comprise:
obtaining, from the user, a spoken audio input signal generated by the user;
providing said audio input signal in the form of an audio input signal and/or in the form of a text input signal (e.g. a transcription of the audio input signal) to one or more language based ML model(s) trained for analyzing an input signal pertaining to the spoken audio input signal;
generate one or more suitable response to such user audio input signal, using one or more language based ML model(s);
where the spoken audio input signal relates to at least one authentication credential, determining from the spoken audio input signal at least one authentication credential, using one or more language based ML model(s) and triggering at least one authentication attempt to the service using the determined at least one authentication credential; and
outputting a response to the user.

Where the ML model generates the response in text, the method may include generating audio from the text response by way of a speech synthesis engine. Where the ML model generates the response in audio, the method may play such audio to the user without the need of a speech synthesis engine.

Where the ML model accepts text input, the spoken audio input signal may be processed into text by way of for example a dictation transcription model. Where the ML model accepts audio input, the spoken audio input signal may be provided directly to the ML model.

In a further embodiment, the one or more language based ML model(s) that generate a response to that input may be prompted, trained, fine-tuned, or otherwise instructed. For example, the method may include collecting the user's name from for example an onboarding experience (e.g. through asking the user for his/her name, transcribing said name, and saving it in a database), and sharing said name (e.g. pulling said name from a database and including it in the prompt to the ML model) with the one or more ML model(s) so that the latter may include the user's name when generating output to be outputted to the user.

In a further embodiment, when prompting one or more ML model(s), the method may include providing such model(s) with some or all of the communication history between the system and the user. This may, for example, allow the one or more ML model(s) to generate responses more personal to the user and/or situation.

In a further embodiment, the method includes saving the successful user credentials (e.g. WLAN ID; password; etc.), so that it may connect automatically to the service in the future.

In a further embodiment, user input may be provided by ways other than audio signal such as for example by text (e.g. using a touch screen), with system output being in audio. In a further embodiment, user input may be provided through an audio signal, and system output may be provided by ways other than audio signal such as for example by text (e.g. displayed on a screen).

Optionally, where the system outputs output to the user, this may include using a visual interface (e.g. a display of the computing system) in addition to or instead of the speech synthesis engine used for output. Likewise, additionally or alternatively, where the system prompts the user for input, this may include using the same or another visual interface (e.g. a display of the computing system) in addition to or instead of the speech synthesis engine used for output. Optionally, where the system selects or receives from the user an authentication credential, the system may include using a visual interface (e.g. a display of the computing system), as may a visual interface be used for any other communication with the user. For example, when providing the user with an opportunity to select a WLAN ID from the one or more detected WLAN IDs as at least one designated WLAN ID, a visual interface may show the one more detected WLAN IDs to assist the user in its selection. Similarly, for example, when a user provides selection data designating at least one of the at least one output WLAN ID, or for example a user provides any authentication input, the system may show the user's input to the user. Optionally, any visual interface may allow for a user to tap to select or otherwise provide input to the system, in addition to being able to provide input to the system through voice.

Note that, throughout the present disclosure, elements of certain embodiments may be combined with elements of other embodiments as described herein, according to what appears logically possible and technically feasible to the skilled person.

Also note that, throughout the present disclosure, if multiple distinct actions are each individually said to be performed by an instance of an object (e.g. a ML model), then the respective instances may of course be one identical instance or may be respectively distinct instances, or may include one or more individual instances performing multiple of said actions and one or more other individual instances performing just one single of said actions.

It is noted that a dedicated speech synthesis engine may be used to generate audio from text (e.g. text output from an ML model, such as for example a large language model), but that it may instead, alternatively or additionally, be the case that the function of speech synthesis is implicitly a part of, or otherwise works with, a larger overall artificial intelligence, AI, element or elements that can provide as output audio, e.g. one or more machine learning, ML, models, such as for example a large language model or multimodal large language models.

A speech synthesis engine (sometimes also called a speech synthesizer or a text-to-speech, TTS, engine) may be taken to refer to an automatic system that converts normal language text or symbolic linguistic representations like phonetic transcriptions into speech or a multimodal or other ML model that can output audio directly.

It is noted that a dictation transcription model (sometimes also called a speech analysis engine, speech recognition system, a speech analyzer or a speech-to-text, STT, engine) may be taken to refer to an automatic speech recognition (ASR) system (e.g. a standalone transcription model or a multimodal or other ML model that can be fed audio input directly) such as for example one trained on (preferably multilingual and multitask) supervised data (e.g. collected from the web) configured to generate text output (preferably in multiple languages, and preferably also configured to provide translation from those languages into a main language such as English).

An audio output signal may comprise an audible signal (e.g. in case the computing system includes its own audio speaker), but alternatively or additionally it also may comprise a digital or analog signal adapted to be filtered and amplified for output on an external audio speaker.

An audio input signal may likewise comprise an audible signal (e.g. in case the computing system includes its own microphone), but alternatively or additionally it also may comprise a digital or analog signal derived directly or indirectly from an external microphone.

Preferably, the method may comprise prompting the user with a check request based on the determined at least one authentication credential. For example, the method may comprise asking the user “So, I have 8 characters, is that correct?”.

The system may use one or more ML models, preferably an LLM model, to achieve conversational communication as for example in the above example and any other communication from the system to the user and/or as part of any embodiment described herein. For example, the system may, in an embodiment, after scanning WLAN IDs and selecting one or more, send a list of the detected WLAN IDs to an LLM model, which may, for example, be configured or trained or prompted, or otherwise instructed to create conversational output capacity, for the LLM model to then create a conversational output on the basis of the provided WLAN IDs to be outputted to the user (e.g. “Hey John, it seems we have three strong WIFI connections here: one starting with BEBOX, one SpectrumF7 and a Spectrum D6—D for Delta, that is—and one with EASYWIFI. Which do you think is yours? ”). The same is possible, for example, when communicating with users regarding authentication and any other communication between system and user.

Additionally, another benefit of having one or more ML model(s) review a transcription of an audio input received from the user is that (i) the transcription may be erroneous, such as for example transcribing a P when it should have transcribed a B, or (ii) the transcription may include also words that are not part of the required input (e.g. a password), such as for example where the user in their input include filler words or additional words or repeat words and the like (e.g. “Sure, the password is BP76, I mean 776, FW twice, so FW and again FW”). The one or more ML model(s) that review the transcription can then determine what the actual password is, as further described herein.

In a further embodiment, the same is addressed where a multi-modal LLM is used, or a non-multimodal LLM that accepts audio as direct input, in which case the audio input can be feeded directly into the LLM (i.e. without need to transcribe it first). In such case, the benefits of having one or more ML model(s) review the input include that the user input may include also words that are not part of the required input (e.g. a password), such as for example where the user in their input include filler words or additional words or repeat words and the like (e.g. “Sure, the password is BP76, I mean 776, FW twice, so FW and again FW”). The one or more ML model(s) that reviews the input can then determine what the actual password is, as further described herein.

In a further embodiment, the method may comprise configuring the at least one language-based ML model to operate using a dictation transcription model.

Note, in a further embodiment, where a one or more ML model(s) is used that accepts audio input directly, e.g. it can accept audio input and process such audio input without needing to convert said audio input into text, there may still be an element of text generation, either as part of the at least one language-based ML model, or a different ML model, in generating text output to be used, for example, in attempting a credential authentication. This text generation may be necessary, for example, where authentication cannot be attempted with audio (e.g. a WLAN credential that can be authenticated only using text). Such text generation may be in JSON or other format (and e.g. not merely contain exclusively a likely user credential but include other content such as for example content to trigger a back-end or other application to conduct an authentication attempt).

Any ML model referred to herein may, for example, be instructed for conversation. Any ML model may, for example, be instructed, trained, prompted, fine-tuned and/or otherwise instructed for the purposes described herein such as for example the processing and/or formatting and/or validation of WLAN passwords or other passwords, or WLAN IDs, or other IDs (e.g. log-in or email address details), or other input that requires precise transcription. Any ML model referred to herein may, for example, be stored and/or run locally on the computing system or in the cloud or a combination thereof.

The one or more ML models may, for example, check the provided user input and determine whether or not the user's input is a WLAN password, for example, or something else (e.g. the input might be a question: “where is my password? ” or a statement: “hold on a minute”) and generate a response (whether for example text (whether for communicating to client, or to the backend (e.g. in JSON format to for example authenticate user), audio or an action).

For example, if the input is likely a password, the one or more ML models may, for example, determine whether further information is needed, or whether the password is (in)complete, or whether it needs to reformat the password for it to be likely complete or correct. The one or more ML models may then (or irrespectively) generate a relevant response and/or follow up to the user (e.g. follow up with a clarification question, or with a status notification (e.g. “I'm trying to connect”) or take any other action (e.g. system may send the password to a backend and trigger one or more authentication attempt(s)).

Further, If the user's input is not a password but a question or some other user comment, the one or more ML models may generate a relevant response and/or follow up to the user.

For the avoidance of doubt, one or more ML models may process user input and interact with the user at any stage of the system (e.g. password input, authentification, WLAN ID determination, or otherwise).

Optionally, in a further embodiment, the voice input from the user, which may be in the form of an audio or audible input signal, in the form of an analog or digital signal where appropriate, and/or in the form of a text input signal, i.e. where that audio signal has gone through one or more transcription models or one or more other models that generates text from audio input, is provided to and processed by one or more ML models, such as, for example, a large language model, a small language model, and/or a multimodal model.

For the avoidance of doubt, voice input may be transcribed into text through a transcription model with such text then being provided to a ML model that can process text input.

In a further embodiment, additionally, the output of such ML model, if in text, may be processed by a text-to-speech ML model which generates audio output and such audio output may be played to the user. Similarly, and alternatively, a multi-modal ML model or a speech-in and/or speech-out model may be used, thereby reducing the number of steps required to process the audio input and generate output (e.g. for an ML model that accepts audio as input, no transcription needs to be undertaken in advance).

Such one or more ML models may be prompted, trained, fine-tuned, authorized, taught or otherwise instructed to process input and do any one of, or all of, but not limited to, the following:
consider whether or not the input that has been inputted is, for example, a potential and/or likely credential (e.g. WLAN password in the case of authentication; in the case of WLAN ID identification then the current analysis would apply in that scenario as well as applicable e.g. determine whether or not the input is a potential and/or likely WLAN ID or other credential; similarly, as applicable in the case of authentication relating to other services). If it considers that the input is a potential and/or likely, or correct and/or complete credential (e.g. a WLAN password), or some other determination as may be set, the one or more models may trigger the backend to, or otherwise seek to, authenticate the user using that password.
additionally, or alternatively, modify the input, whether according to a set criteria or not, so that it is more likely to be a correct credential (e.g. a WLAN password). For example, if the input includes a “PP”, the model(s) may modify it to “BB”, or “BP”, or both (e.g. create numerous versions of it), and may trigger the backend to, or otherwise seek to, authenticate user access using the modified credential (e.g. a password), in addition to, or as alternative(s) to, the non-modified input, and the model(s) may do so (e.g. modify the user credential input, such as password input) multiple times. Thus, for example, the system may try authenticating with a potential password containing “PP”, and/or one containing a “BP” or similar. This may be done in parallel to any other action, and/or in conjunction, but also in disparate steps. Similarly, for example, if the input is “capital c double small p”, it may convert this into “Cpp”.
generate output for the system to communicate to the user, whether in text, and optionally with the text being processed through a speech synthesis engine, e.g. a text to speech engine, or alternatively in a multi-modal system or other system, generate audio output directly. Output may serve different purposes (e.g. to respond to a user question or, for example, to provide a notification to the user), and also with different effects (e.g. intonation, speed of speech, etc). The model(s) may be prompted, trained, fine-tuned, authorized, taught, or otherwise instructed to do any one of, or all of, of, but not limited to, the following, for example:
clarification: system may wish to request clarification or confirmation or similar from the user. For example, when the model(s) decides that it doesn't know (e.g. it did not pick up a credential from the user's input, or for example the system is otherwise unsure of the right credential), or otherwise wishes clarification on the user's credential (e.g. password), and/or the system wishes to clarify for example whether the user's input included, for example,, a “P” or a “B”, or for example, an “N” or an “M”, the system may converse with the user, and thus for example, the model may generate output to ask the user whether the user meant “P” or “B, “N” or “M” (e.g. system: “Sorry, dear, did you mean “N” for Nigeria, or “M” for Mayday”, or “Thank you for this. Is your password “XXPXX” or “XXBXX”). Thus the system may interact with the user to obtain clarifications or confirmations. Similarly, for example, the system may notice that the input is too short for a password, or is missing one or more digits. Model(s) may then generate output which the system uses to interact with the user requesting for the additional elements of the password, or otherwise request the full password from the user (e.g. System: “Sorry dear, you seem to have missed a few digits of your password. Shall we try again? ” or “Oops! There seems to be an incomplete or wrong password. Shall we try that again? ”).
notification: system may want to provide the user with, for example, an error message or success message (or other message) when seeking to authenticate, or otherwise notices, for example, an error in the user's password input, such as for example status notifications or other outputs. For example, as regards process update notification, the model may generate, and the system may communicate to the user the following output: “Thanks so much, let me test that quickly and I'll let you know if I have a question.”
conversational assistance: system may respond to user input and/or participate in conversation, where for example the model(s) understand or otherwise assume(s), that the input was conversational, or the user may otherwise benefit from conversational output, such as for example, if the input from the user was “Hey, I actually can't find my password, I'm looking at the sticker and I see a disk and a net.” The system can say “Oh, it's actually the disk, not the net.” Another example: the user says “Okay, give me a minute, I'm going to look for it.”; the system can respond “Got it, I'm here and ready to help whenever you're ready.” Another example: the user says: “How many digits are still missing? ”; the system can respond to it. Further, the model(s) may participate in any form of conversation(s) that may assist the user or otherwise benefit them.

For the avoidance of doubt, a user's input, and a system's output, may include individually spoken symbols, including symbols, characters, letters and digits, and the like.

In a further embodiment, the method may comprise of having the system obtain audio input signal from the user, using an ML model determine an authentication credential from that input, using an ML model generate one or more additional alternative authentication credentials on the basis of the audio input, and triggering at least one authentication attempt using at least one of the generated credentials. Where such one or more authentication attempts fail, the system may prompt the user to provide a clarification of the at least one part of the voice input, and then determine as described above. For the avoidance of doubt, authentication attempts may be triggered before, while or after alternative possible credentials are being generated.

In various embodiments, the user input may include, in addition to or separate from the at least one authentication credential, or alternatively to it, other input (e.g. a question to the system such as “Where can I find my password? ”) to the system. In such a case, the method may comprise processing from a spoken audio input signal the input of the user, using at least one language-based machine learning, ML, model trained for analyzing an input signal pertaining to the spoken audio input signal; and an at least one ML model may generate a response to such input. The response may be communicated to the user using a speech synthesis engine.

In various embodiments, the method comprises: if at least one part of the voice input, in the form of an audio input signal and/or in the form of a text input signal (e.g. where the audio input has been transcribed to text), fails to meet at least one certainty criterion:
prompting the user to provide a clarification of the at least one part of the voice input; and
optionally, in parallel with said prompting, if the voice input relates to an authentication means, triggering at least one authentication attempt, using the received authentication means and/or another authentication means generated by a ML model while prompting or while waiting for a response to said prompting.

Any of the prompting and any other output to the user can be supported, generated or otherwise prompted to the user through one or more ML models, allowing for conversational engagement and interaction.

In various embodiments, the method comprises: if at least one part of the voice input, in the form of an audio input signal and/or in the form of a text input signal (e.g. where the audio input has been transcribed to to text), fails to meet at least one certainty criterion:
prior to prompting the user to provide a clarification of the at least one part of the voice input, triggering an at least one authentication attempt, using the received authentication means and/or another authentication means generated by a ML model,

Or alternatively,
while prompting the user to provide a clarification of the at least one part of the voice input or while waiting for a response to said prompting, triggering at least one authentication attempt, using the received authentication means and/or another authentication means generated using machine learning.

An ML model, preferably an LLM, may be used to determine whether or not the user input, whether in the form of an audio input signal and/or in the form of a text input signal (e.g. as the audio has been transcribed to text), fails to meet one or more certainty criterions. An ML model may be prompted, trained, fine-tuned or otherwise instructed to do so.

An ML model, preferably an LLM, may be used to reconstruct the user's input, including but not limited by extracting from the input what the authentication credential may be (e.g. the user's input is “Oh, hmmm, yes, let me check my password . . . mmmm . . . I think it is ABBC76, oh sorry, 776, TTK mmm I think”; the model may extract as the likely password “ABBC776TTK”), and/or by creating or generating additional potentially possible passwords (e.g. in the previous example, create as possible passwords ABBC776TTK, ABC776TTK, APPC776TTK, ABPC776TTK, APBC776TTK). An ML model, preferably an LLM, may be prompted, trained, fine-tuned or otherwise instructed to do so, and one or more of the possible passwords (i.e. the passwords generated) may be used when triggering an authentication attempt.

Note that another benefit of the methods described herein is clearly visible in these examples. For example, if only a transcription model were used without an ML model to process the user input, and one would use the mere transcription to authenticate, the system may try to authenticate using the following as the password, “Oh, hmmm, yes, let me check my password . . . mmmm . . . I think it is ABBC76, oh sorry, 776, TTK mmm I think”, which would be unsuccessful.

The above and similar methods allow, for example, where user input is unclear (e.g. user stated: “NXT 123” with the first letter being “N”; though it is not always clear whether the user stated “NXT 123” or “MXT 123”, due to, for example, the similarity of the letters' pronunciation, with the first letter potentially being “M”) for the system to make an authentication attempt for both “NXT 123” and, if necessary, “MXT 123”, prior to (or at the same time as) prompting the user for clarification of input (e.g. “Do you mean “NXT”, with the first letter being “N” for November or “M” for Mike? ”) and, where necessary, such as if authentication attempt(s) fail, then to prompt the user, or, alternatively, while making one or more authentication attempt, prompting the user for clarification as such. This makes, in some embodiments, for example, the prompting of the user for clarification of the user's input optional allowing the system to skip this step where it is not necessary, as for example the system has figured it out and/or made a successful authentication attempt, or in parallel with said prompting, and the system may, additionally and as an example, manipulate, or guess, the input (e.g. trying “N” and “M” or, as other examples, “B” and “P”, a forward slash (i.e. “/”) and a backwards slash (i.e. “\”) or any other unclear user input) and try multiple authentication attempts prior to requesting further user input or clarification, or, for example, simultaneously to this, or prior to, for example, providing error or other notifications to the user.

In a further embodiment, the ML model may provide its output in a JSON or other format whether for example using function calling tools, or similar tools, or not, which can then trigger action on, for example, the backend, such as for example submitting the password and authenticating the user. In a further embodiment, where the ML model is able to take action (e.g. authenticate a user), its output may be such action. In a further embodiment, one or more ML models may be prompted, trained, tuned or otherwise instructed to extract and or generate content such as for example a user credential, and to do so in a certain format. A backend program, for example, or an ML model, may then take such output and take action such as for example attempting authentication.

For the avoidance of doubt, the output of any of the steps of the embodiments described herein may be in, or otherwise include, a JSON or other format, such as for example where the output is agentic, such as for example function calling or other action.

It is noted that in various embodiments, in situations not necessarily relating to WLANs, though also in such situations, for example where a user wishes to authenticate to for example a service (e.g. an online website or an app, etc.), for example through the use of a username and/or password (or, as another example, security questions, e.g. “Where were you born? ”; “What's the number we texted you? ”, etc), any methods may so be adapted to obtain from the user's input, for example, a username and/or password. For example, in various embodiments, the system may be configured to determine from the user's input the authentication means, and trigger at least one authentication attempt to the service using the received authentication means. In a further embodiment, the user's input may be processed by at least one ML model, preferably an LLM model, to be processed as described herein. The system may also, in terms of for example a user name or user ID and the like, be configured to assume what those may be (e.g. because the system already has knowledge of user's email address or the user's name(s)) and thus be configured to prompt the user only for the password (or at least prompt the user first only for the password, and only if the authentication attempt(s) is/are unsuccessful, be configured to confirm to the user, or request from the user a username or ID or any other input). In further embodiments, the system may utilize speech and voice recognition algorithms for authentication, in addition to the methods and systems described herein.

In a further embodiment of the present disclosure, there is provided a method of authenticating a user to a service; the method comprising, on a computing system:
obtaining, from the user, a spoken audio input signal comprising input content;
determining from the spoken audio input signal the input content, using at least one language-based machine learning, ML, model trained for analyzing an input signal pertaining to the spoken audio input signal; and
where this determined input content contains at least one authentication credential for the service, triggering at least one authentication attempt to the service using the determined at least one authentication credential; and where this determined input content contains other input (e.g. a question; other input from the user to the system), triggering a response(s) to the input. For the avoidance of doubt, it is noted that the spoken audio input content may include both at least one authentication credential for the service as well as other input, with the method taking the relevant steps for each.

In a further embodiment, the at least one ML model may determine whether or not it should (i) determine at least one authorisation credential (e.g. because the user's input contains a plausible authentication credential), (ii) generate a response to the user's input (e.g. respond to a user question), (iii) perform both of these actions, and/or (iv) perform any other kind of action, and upon determining the right action(s), undertake said action(s). For example, a user says: “My password is FYG123; let me know if this password works or if you need another one.”; the one or more ML model may take the following actions (though is not limited to these example steps): (i) determine at least one authentication credential, (ii) trigger an authentication attempt with that at least one authentication credential, and (iii) generate a response to the user stating that it is attempting to authenticate, and anything else (e.g. “Thank you, I'll let you know if anything else is needed.” In a further embodiment, any such response, where such response is in text, may be output (e.g. played) to the user after being processed from text to audio through a speech synthesis engine). In an embodiment, the one or more ML models may be tasked, whether implicitly or explicitly, with determining, whether the user input contains a possible authentication credential, and or contains other user input to which the one or more ML model(s) may generate a response.

The skilled person will understand that wording used in any of the embodiments described herein may be used in whole or in part in the other embodiments claimed and/or described in the present disclosure.

It is noted in general that, where an embodiment of the system according to the present disclosure is described as being configured for a particular action, the skilled person may of course understand this to mean that there are computer instructions on the system (i.e. stored in the at least one memory of the system), which computer instructions are specifically configured for that particular action (i.e. to cause the system to perform that particular action). By extension, the skilled person will appreciate that, whenever in the present disclosure it is disclosed for any embodiment that the at least one memory stores computer instructions configured for causing the system to perform a particular action (or similar wording), this may mean that various embodiments of the method according to the present disclosure may comprise a step of actually performing that particular action. Vice versa, the skilled person will appreciate that, whenever in the present disclosure it is disclosed for any embodiment that the method comprises a particular step, this may mean that various embodiments of the system according to the present disclosure may be arranged such that the at least one memory stores computer instructions configured for causing the system to perform that particular action.

Likewise, it is also noted in general that, where an embodiment of the system according to the present disclosure is described as comprising a certain module or unit or the like, having a specific functionality, the skilled person may of course understand this to imply that there may be computer instructions on the system (i.e. stored in the at least one memory of the system), which computer instructions are specifically configured for that specific functionality (i.e. to cause the system to perform that specific functionality). By extension, the skilled person will appreciate that, whenever in the present disclosure it is disclosed for any embodiment that the at least one memory stores computer instructions configured for causing the system to perform a particular action (or similar wording), this may mean that various embodiments of the system according to the present disclosure may comprise corresponding functional units or modules or the like, and that these may be implemented as a stand-alone unit within the system, or as an integral part of the hardware and/or software of the system.

As used in this application and in the claims, the singular forms “a,” “an,” and “the” include the plural forms unless the context clearly dictates otherwise. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently or intrinsically. Moreover, for the sake of simplicity, the attached figures may not show the various ways in which the disclosed systems, methods, and apparatus can be used in conjunction with other systems, methods, and apparatus. Additionally, the description sometimes uses terms like “obtaining” and “outputting” to describe the disclosed methods. These terms are high-level abstractions of the actual operations that are performed. The actual operations that correspond to these terms will vary depending on the particular implementation and are readily discernible by the skilled person.

It will be appreciated that for simplicity and clarity of illustration, where appropriate, reference numerals may have been repeated among the different figures to indicate corresponding or analogous elements. In addition, numerous specific details are set forth in order to provide a thorough understanding of the examples described herein. However, it will be understood by the skilled person that the examples described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the examples described herein.

The skilled person will understand that the present invention may be implemented in other ways than those specifically set forth herein without departing from the essential characteristics of the invention. The embodiments described herein are thus to be considered in all respects as illustrative and not restrictive, and all changes within the scope of the appended claims are intended to be embraced therein.

What is claimed is:

1. A method of authenticating a user to a service; the method comprising, on a computing system:
obtaining, from the user, a spoken audio input signal relating to at least one authentication credential for the service;
determining from the spoken audio input signal the at least one authentication credential, using at least one language-based machine learning, ML, model trained for analyzing an input signal pertaining to the spoken audio input signal; and
triggering at least one authentication attempt to the service using the determined at least one authentication credential.

2. The method of claim 1, wherein the service is any one or more selected from the following: a wireless local area network; a virtual private network; and a digital account, such as a personal computer account or a social media account, an email account, a banking account, etc.

3. The method of claim 1, wherein the language-based ML model is a large language model, LLM, or is based on a LLM.

4. The method of claim 1, wherein said step of determining comprises:
providing said at least one authentication credential, in the form of an audio input signal and/or in the form of a text input signal, to the at least one language-based ML model and prompting the at least one language-based ML model to obtain at least one variant representation of said at least one authentication credential;
wherein the at least one language-based ML model is configured to take as input an initial representation, and to output one or more variant representations comprising one or more probable corrections to the initial representation.

5. The method of claim 1, comprising operating the at least one ML model to process some or all spoken audio input signal as a dictated input.

6. A method of authenticating a user to a wireless local area network, WLAN, the method comprising, on a computing system:
obtaining, from the user, a spoken audio input signal relating to at least one of: an identifier, ID, for the WLAN, and a password for the WLAN;
determining from the spoken audio input signal the ID and/or the password, using a language-based machine learning, ML, model trained for analyzing an input signal pertaining to the spoken audio input signal; and
triggering at least one authentication attempt to the WLAN using the determining ID and/or password.

7. The method of claim 6 further comprising:
obtaining, from the user, a second spoken audio input signal relating to a password for the WLAN;
and determining from the second spoken audio input signal the password, using a language-based machine learning, ML, model trained for analyzing an input signal pertaining to the spoken audio input signal, before the step of triggering at least one authentication attempt to the WLAN using the determined ID and password.

8. The method of claim 6, further comprising:
detecting an identifier, ID, for the WLAN by scanning a radio frequency range accessible to the computing system.

9. The method of claim 8, wherein said step of detecting the ID for the WLAN by scanning comprises:
if no IDs are detected in said scanning, outputting a failure notification to the user, and re-attempting or halting the method;
if one ID is detected in said scanning, setting said one ID as the ID of the WLAN to be authenticated to; or
if multiple IDs are detected in said scanning, either:
transparently to the user, and optionally in an iterative manner, selecting at least one ID from the multiple detected IDs as the ID of the WLAN to be authenticated to, by making use of a pre-defined heuristic, preferably based on ranking respective Relative Signal Strength Identifier, RSSI, values of the multiple detected IDs; or
outputting to the user at least one ID of the multiple IDs;
receiving from the user selection data designating an ID of the at least one output ID; and
selecting the designated ID as the ID of the WLAN to be authenticated to.

10. The method of claim 9, wherein the at least one ID of the multiple IDs is output to the user via a visual display or an audio speaker or a combination thereof; and wherein the selection data from the user comprise a spoken audio selection input signal or a click or touch selection input signal.

11. A computing system for authenticating a user to a service; the computing system comprising at least one processor and at least one memory the at least one memory storing computer-executable instructions configured for, when executed by the processor, causing the computing system to perform:
obtaining, from the user, a spoken audio input signal relating to at least one authentication credential for the service;
determining from the spoken audio input signal the at least one authentication credential, using at least one language-based machine learning, ML, model trained for analyzing an input signal pertaining to the spoken audio input signal; and
triggering at least one authentication attempt to the service using the determined at least one authentication credential.
